(19) United States
(12) Patent Application Publication
(10) Pub. No.: US 2002/0085158 A1
(43) Pub. Date: Jul. 4, 2002

(54) BALL GRID ARRAY MOUNTED LIQUID CRYSTAL DISPLAY PANELS

(76) Inventors: KARL M. ARMAGOST, BOULDER, CO (US); JAMES G. KOLM, LONGMONT, CO (US); EDWARD R. POLLARD, SUPERIOR, CO (US); GABOR A. TOTH, EVERGREEN, CO (US); JEFFREY F. HAMBLETON, DENVER, CO (US)

Correspondence Address: BLAKELY SOKOLFF TAYLOR & ZAFMAN LLP, 12400 WILSHIRE BOULEVARD SEVENTH FLOOR, LOS ANGELES, CA, 90025

(21) Appl. No.: 09/313,222

(22) Filed: May 17, 1999

(51) Int. Cl. G02F 1/1345

(52) U.S. Cl. 349/149

(57) ABSTRACT

The present invention relates to a display assembly having a liquid crystal on silicon display device disposed on a first substrate and having first electrical contact pads. The display assembly also has a second substrate having second electrical contact pads coupled to the first electrical contact pads and having an array of ball contact elements. Various embodiments and features are disclosed.

### BACKGROUND OF THE INVENTION

1. Field of the Invention

The present invention relates generally to packaging liquid crystal display panels and more particularly to mounting liquid crystal display panels onto a substrate using ball grid array.

2. Background Information

Conventional flat-panel displays use electroluminescent materials or liquid crystals in conjunction with incident light to produce high quality images in products such as digital wristwatches, calculators, panel meters, thermometers, and industrial products. Liquid crystals are a state of matter that mixes the droplet or pouring property of a liquid and the long-range order property of a solid. This combination allows an optical activity having a magnitude without parallel in either solids or liquids. Further, when a magnetic or electrical field is applied normal to the liquid crystal material, the liquid crystal material forms a localized monocrystal that is polar in character. This localized polarization of the liquid crystal material affects the travel path of light incident to the liquid crystal material. By controlling the electrical field applied across the liquid crystal material, the travel path of light incident to the liquid crystal material can be controlled to help produce high quality images.

Modern approaches for developing high quality liquid crystal displays (LCDs) utilize the active-matrix approach in which thin-film transistors (TFTs) are co-located with the LCD pixels. Micro liquid crystal display panels may be those displays having a two inches or less diagonal viewing screen. Micro-displays are an emerging, enabling technology; that is, micro-displays will enable many people to design and develop countless new products to the betterment of humankind. To get a sense of the compactness of a micro-display, a Super Video Graphics Array (SVGA) display may have a 600 by 800 pixel matrix (480,000 pixels) within a 0.9 inch diagonal viewing screen.

Reflective micro-displays sandwich a liquid crystal material between a reflecting material such as aluminum and a glass cover that permits light to enter the liquid crystal material. Due to small size of micro-displays, micro-displays require the drive circuitry of an integrated circuit to be integrated into the display panel along with the pixel transistors. Typically, the drive circuitry is integrated into the display substrate that is located below the reflecting material. Because the drive circuitry must be integrated with the display substrate, microdisplays are generally limited to high quality transistor technology such as single crystal (x-Si) and polysilicon (p-Si).

Thus, in general, reflective micro-displays are usually based on single-crystal silicon integrated circuit substrates with a reflective aluminum pixel forming a pixel mirror over the pixel transistors and addressing lines. Buses or leads are used to communicate power, ground and other signals between these transistors and addressing lines and devices external to the micro LCD panels.

The pattern of the electrical leads of a micro-display may be as small as fifty-two leads within a distance of 12.1 millimeters (i.e., lead pitch is 0.22 millimeters between each lead). To package the micro-display for use in other products, the micro-sized pattern of the electrical leads of the micro-display needs to be rearranged into a pattern that is usable by existing connectors. One known technique is to first mechanically attach the LCD panel to a rigid printed circuit board that extends in one direction into a flexible printed circuit board. At the end of the flexible printed circuit board is a male connector of a conventional pattern that fits into conventional female sockets mounted to a driver board. To form electrical paths between the micro LCD panel and the rigid printed circuit board, micro-wire bonds are sonic welded between the electrical leads of the micro LCD panel and the rigid printed circuit board.

The use of a flexible printed circuit has several advantages. It is a low profile method of mounting that is relatively inexpensive that is readily available. However, because the flex circuit extends from only one side of the LCD panel, the driver devices on the driver board must be located so as to account for the orientation of the flex circuit. The driver devices also must be located away from the viewing screen of the LCD panel by the length of the flex circuit, resulting in longer buses that increase the chance of picking up noise as well as diminishing the signal power. Since the socket is a function of the flex circuit, it would seem that original equipment manufacturer (OEM) designers are limited in their choice of female sockets. Even worse, most custom designers request a custom flex circuit lead to fit their choice of female socket. The lack of a universal package requires maintaining several product lines for essentially the same product. This increases the unit cost of each micro LCD panel.

Since real estate on a driver board is at a premium, there is a need to shrink the packaging footprint of existing micro LCD panels. There is also a need to employ a universal connector that allows OEM designers to arrange the micro LCD panel in any position they choose while eliminating the requirement for a female socket mounted to the driver board.

### SUMMARY OF THE INVENTION

The present invention relates to a display assembly having a liquid crystal on silicon display device disposed on a first substrate and having first electrical contact pads. The display assembly also has a second substrate having second electrical contact pads coupled to the first electrical contact pads and having an array of ball contact elements. Various embodiments and features are disclosed.

### BRIEF DESCRIPTION OF THE DRAWINGS

FIG. 1 show a side view of liquid crystal display 100 mounted to flexible printed circuit board 120.

FIG. 2 shows bond pads 122 as extended by traces 124 into male connector 130.

FIG. 3 is an isometric exploded view of an embodiment of the invention.

FIG. 4 illustrates BGA fabrication 310 with mount side 312 facing up.

FIG. 5 shows an array of ball contact elements 370 populating BGA fabrication 310.

FIG. 6 is a schematic wiring diagram of BGA fabrication 310.

FIG. 7 highlights the use of capacitors 376 in schematic wiring diagram 374 of FIG. 6.

FIG. 8 illustrates a preferred arrangement of capacitors 376 on BGA substrate 300.

FIG. 9 is a detailed view of height beads 340 taken from detail line 9-9.

FIG. 10 is a section view of height beads 340 taken off line 10-10.

FIG. 11 is an exploded isometric view of LCOS device 210.

FIG. 12 illustrates LCOS device being mounted to BGA substrate 300.

FIG. 13 shows an isometric top view of display cover 500.

FIG. 14 shows an isometric plan view of display cover 500.

FIG. 15 is an isometric view of the back side of display cover 500.

FIG. 16 is an isometric view of display assembly 200 in its ready to ship configuration.

FIG. 17 is section view of display assembly 200 of FIG. 16 taken off of line 17-17.

### DETAILED DESCRIPTION OF THE INVENTION

Referring to the figures, exemplary embodiments of the invention will now be described. The exemplary embodiments are provided to illustrate aspects of the invention and should not be construed as limiting the scope of the terms of the invention. The exemplary embodiments are primarily described with reference to block diagrams or flowcharts. As to the flowcharts, each block within the flowcharts represents both a method operation and an apparatus element for performing the method operation. Depending upon the implementation, the corresponding apparatus element may be configured in hardware, software, firmware or combinations thereof.

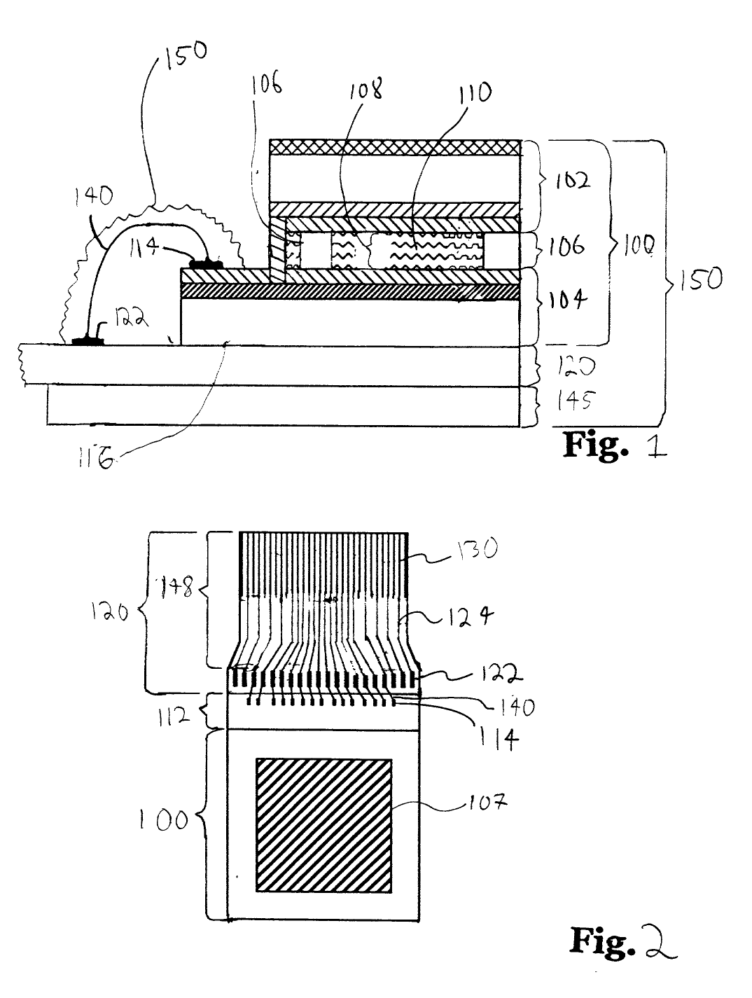

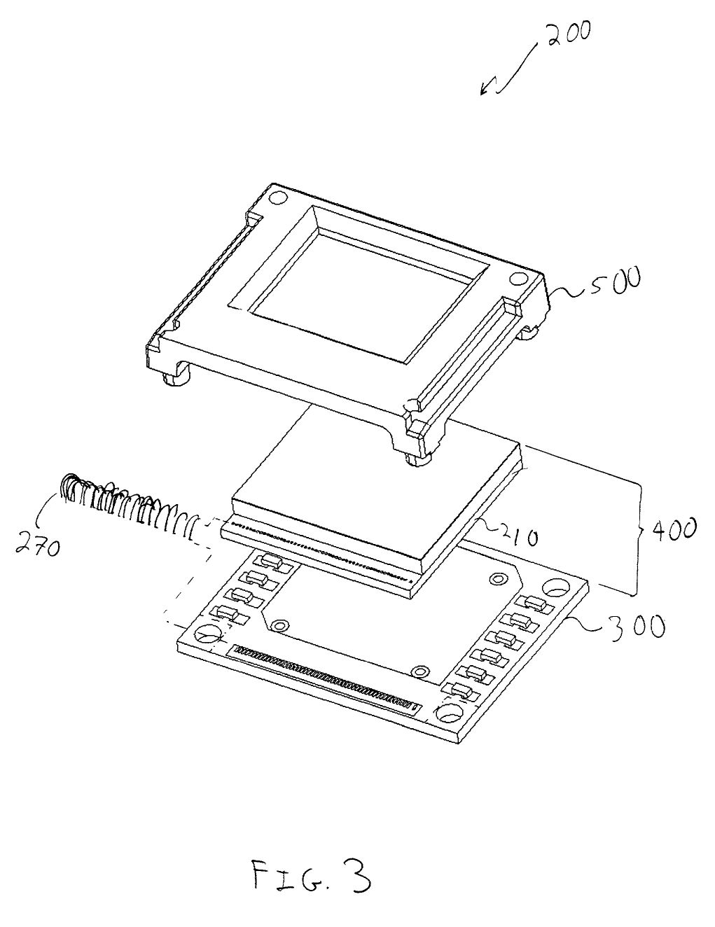

FIG. 1 show a side view of liquid crystal display 100 mounted to flexible printed circuit board 120. Liquid crystal display 100 is made of glass cover 102 maintained a distance away from circuit substrate 104 by spacers 106. This distance forms gap 108 into which liquid crystal material 110 is placed. Between spacers 106 is image viewing area 107 (FIG. 2) on which color images may be presented. Bond pads 114 may be provided on exposed portion 112 (FIG. 2) of display 100 as electrical contact points to permit devices external to display 100 to communicate with display 100, such as communicate with the circuitry within circuit substrate 104.

As shown in FIG. 1, underside 116 of liquid crystal display 100 mechanically is attached to flexible printed circuit board 120, preferably using a solvent-free, thermal-set adhesive. Flexible printed circuit board 120 consists of bond pads 122 that permit board 120 to be electrically couple to liquid crystal display 100. FIG. 2 shows bond pads 122 as extended by traces 124 into male connector 130. Male connector 130 has a flat, conventional profile that can fit into any existing female flex circuit socket. For example, connector 130 may fit into a Zero Insertion Force (ZIF) socket mounted on a printed circuit board containing the device driver that runs liquid crystal display 100.

Flexible printed circuit board 120 of FIG. 1 may be electrically connected to display 100 using wire bonds 140. Wire bonds 140 may be aluminum-wedge wire bonds. The bonding process may be performed by sonic welding at room temperature. Bonding wires 140 then may be encapsulated with encapsulant 150. Encapsulant 150 may be a solvent-free, ultra-violet curable adhesive to protect the delicate wire bonds 140 from damage.

To further protect the electrical connection at wire bonds 140, stiffener 145 may be added under a portion of flexible printed circuit board 120 to complete LCD package 150. In one sense, stiffener 145 provides support to display panel 300 and yet allows flexibility at flex portion 148 of connector 130.

FIG. 3 is an isometric exploded view of an embodiment of the invention. Display assembly package 200 may be formed first by electrically assembling liquid crystal on silicon (LCOS) display cell or device 210 onto ball grid array (BGA) substrate 300. Wire bonds 270 are sonic welded between LCOS device 210 and BGA substrate 300 to form assembly 400. To complete display assembly package 200, display cover 500 is placed over LCOS display device 210 and snapped into place on BGA substrate 300.

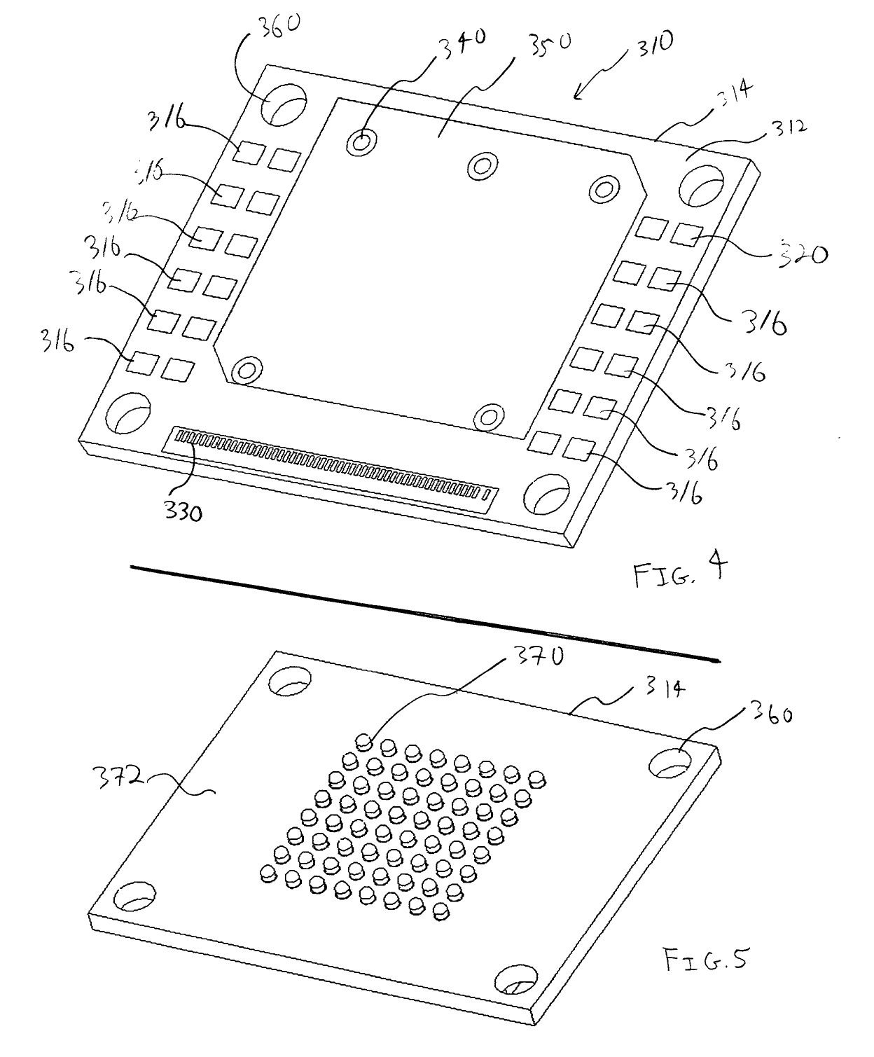

FIG. 4 illustrates BGA fabrication 310 with mount side 312 facing up. BGA fabrication 310 preferably is a six layer rigid printed circuit board wherein each layer consists of Fire Resistant 4 (FR4) board material onto which one half ounce copper traces are disposed. The copper traces are connected by through holes formed into the FR4 boards. Preferably manufactured in accordance with IPC-A-600E, each of the exposed areas are gold plated (120 mlN NI, 8 mlN AU).

The features of fabrication 310 include carrier board 314, capacitor contact pads 316, resistor contact pads 320, electrical contact pads 330, height beads 340, surface 350, and cover holes 360. Carrier board 314 preferably is a multi layered FR4 board. Capacitor contact pads 316, resistor contact pads 320, electrical contact pads 330 serve as pads for capacitors, resistors, and sire bonds, respectively. Cover holes 362 are used to couple display cover 500 to BGA substrate 300.

Height beads 340 may be view as three or more preferably hemispherical beads disposed on surface 350 to a set height. The set, uniform height of height beads 340 gage the distance in which LCOS device 210 resides above BGA substrate 300. This permits metering the amount of epoxy necessary to mechanically and thermally bond LCOS device 210 to BGA substrate 300.

FIG. 5 shows an array of ball contact elements 370 populating BGA fabrication 310. Balls 370 populate carrier board 314 on contact side 372 as arranged in an array matrix. Primarily, balls 370 serve as a conduit that routes signals to and from LCOS device 210.

Of the preferable configuration of 64 balls of BGA fabrication 310, LCOS device makes electrical signal use of 52 balls in a preferred embodiment. Twelve ball have been adapted in the invention as a thermal area to help conduct heat out the back of BGA substrate 300 into the circuit board on which it is mounted.

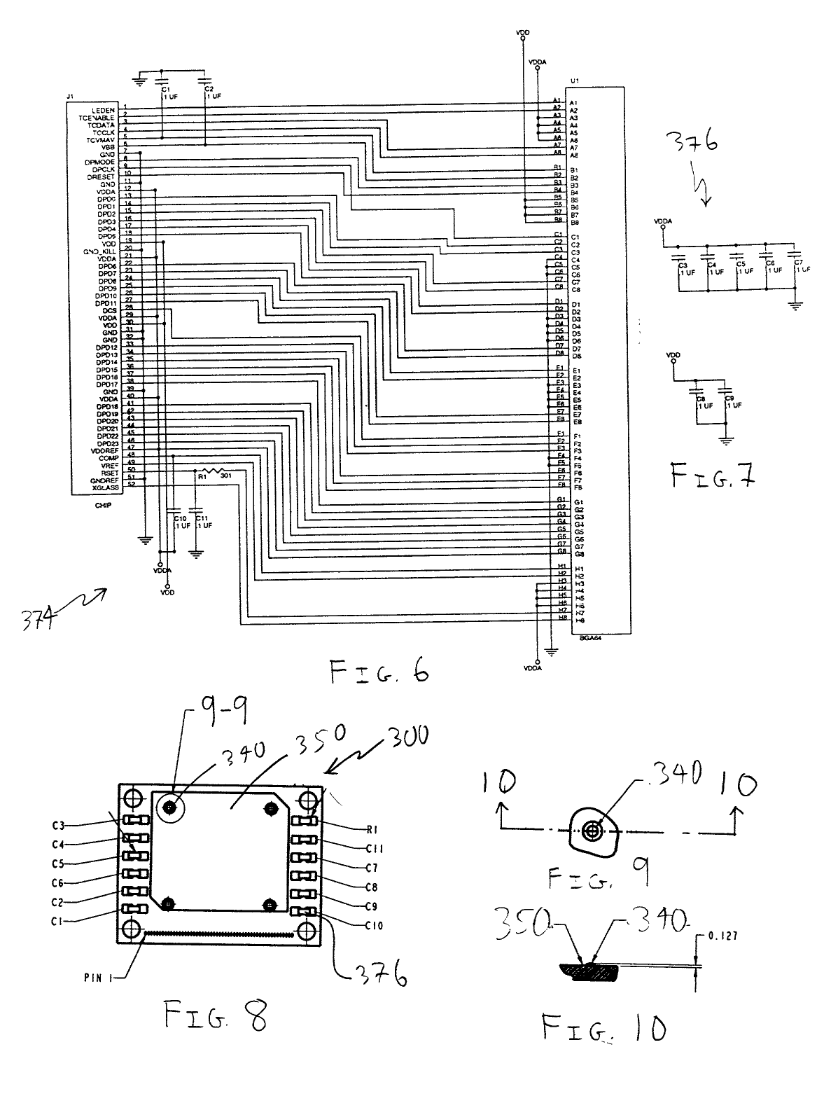

FIG. 6 is a schematic wiring diagram of BGA fabrication 310. FIG. 7 highlights the use of capacitors 376 in schematic wiring diagram 374 of FIG. 6. In a micro display, variations in the supplied power of greater than one percent are visible to the human eye. Display assembly package 200 uniquely takes advantage of close couple capacitating in a package having a LCOS display mounted to a ball grid array. Close couple capacitating aids in keeping the display signal clean without interference.

Capacitors 376 preferably are used as bypass capacitors for the power disbursed within BGA substrate 300. Each capacitor 376 works to filter noise off the power and ground coming into LCOS display 210 by holding power so that LCOS display 210 can quickly draw off this power when needed.

Capacitors 376 may reside within a 18.0 millimeter (mm) by 18 mm perimeter where LCOS display 210 is disposed within this perimeter. Preferably, there are eleven capacitors, wherein each capacitor resides as close as possible to LCOS device 210 to filter the power and ground. In one embodiment, capacitors 376 reside within a 9.0 mm by 18 mm perimeter where LCOS display 210 is disposed within this perimeter.

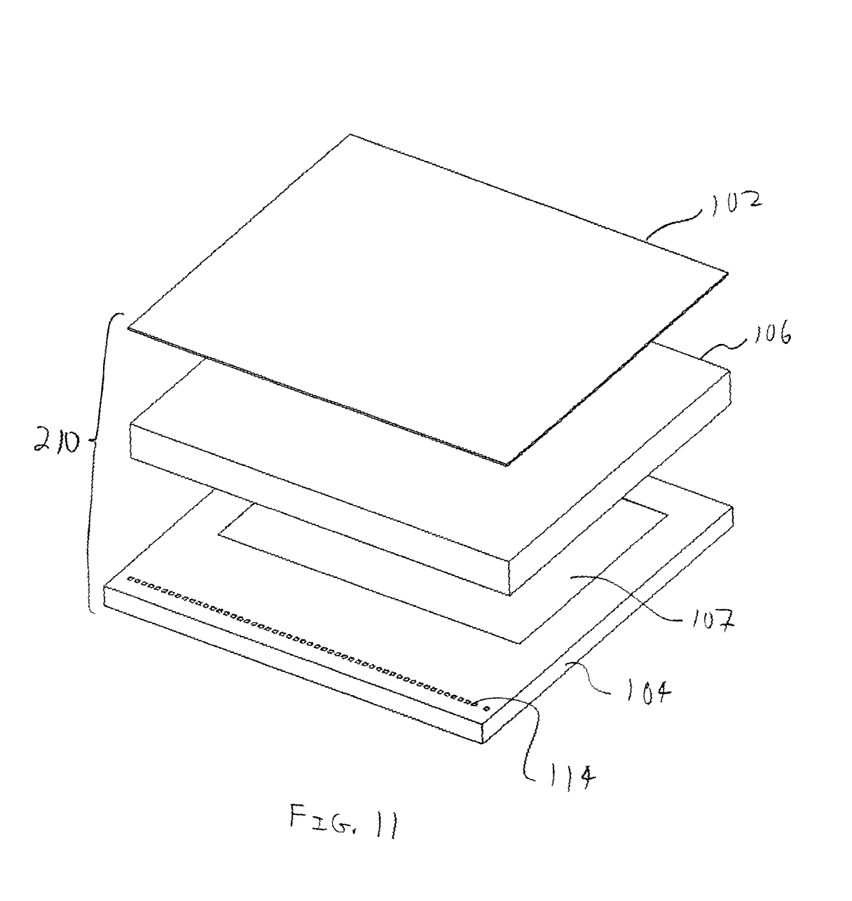

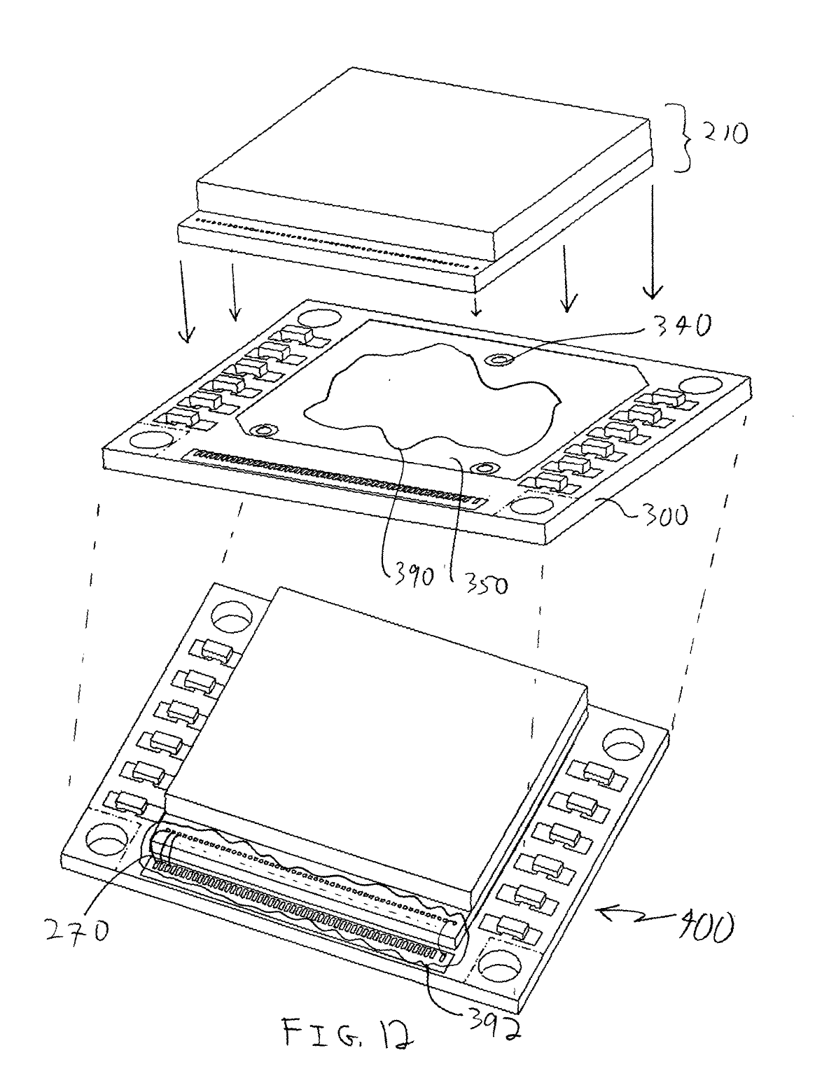

FIG. 8 illustrates a preferred arrangement of capacitors 376 on BGA substrate 300. FIG. 9 is a detailed view of height beads 340 taken from detail line 9-9. FIG. 10 is a section view of height beads 340 taken off line 10-10. As seen in FIG. 10, height bead 340 preferably is spherical in shape and resides approximately 0.127 mm above surface 350.

FIG. 11 is an exploded isometric view of LCOS device 210. As seen, glass cover 102 is disposed adjacent to circuit substrate 104 by spacer 106 over viewing area 107. This alignment leaves bond pads 114 exposed for subsequent electrical connection.

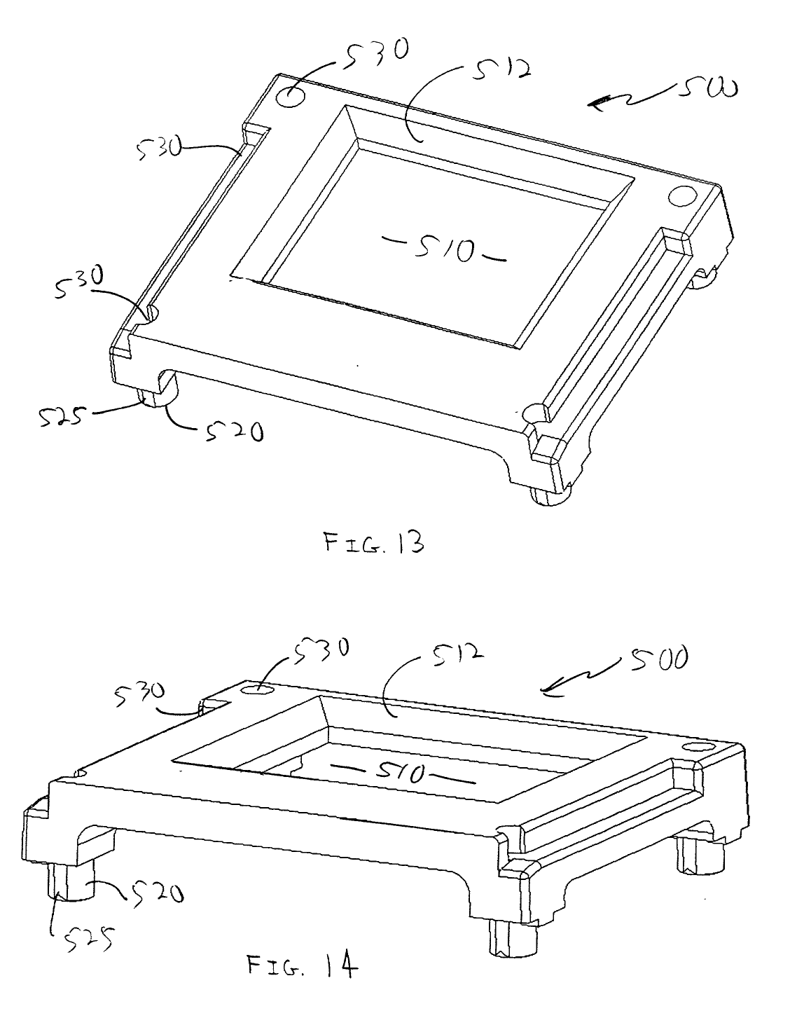

FIG. 12 illustrates LCOS device being mounted to BGA substrate 300. First, adhesive 390 is disposed onto surface 350 of BGA substrate 300. Preferably, adhesive 390 is a thermally conductive epoxy. LCOS device 210 is then picked and placed onto BGA substrate 300 and pressed until LCOS device 210 comes into contact with height beads 340. As noted above in connection with FIG. 4, the uniform height of height beads 340 ensure that the measured amount of adhesive 390 does not ooze beyond the footprint of LCOS device 210. Wire bonds 270 are then sonic welded into place as shown in FIG. 12. To complete assembly 400, wire bonds 270 are covered with encapsulant 392 to protect the wire bonds.

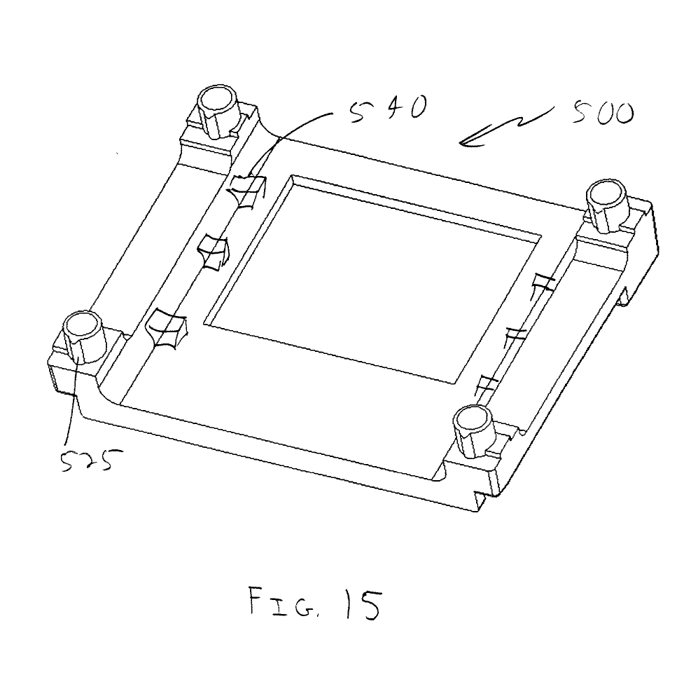

FIG. 13 shows an isometric top view of display cover 500. FIG. 14 shows an isometric plan view of display cover 500. As seen in FIG. 14, display cover 500 has aperture 510 and press fit pins 520. Aperture 510 serves as a framed opening for viewing area 107 of LCOS device 210. As a dark, non-reflective surface, bevel 512 directs stray light away from the view's eyes so that the viewer does not pick up on any stray light reflection. Bevel 512 preferably is at a 45 degree angle. Preferably black General Electric PBT resin such as Vailox™ or some other light absorbing color, aperture 510 serves to block out any extraneous or stray or reflected light. In another embodiment, display cover 500 is formed of encapsulant material molded in place over assembly 400.

Press fit pins 520 preferably are cylinder in shape and have jog 525 raidally extending there from to provide a press fit into cover holes 360 of BGA fabrication 310. With real estate being a premium on all electronics, the embodiment of display cover 500 for a press fit on to BGA substrate 300 creates a smaller foot print for display assembly package 200, thereby permitting more room on the device driver board for other electronic components.

Display cover 500 may be thought of as a controllable interface gauging surface. When display assembly package 200 is use, magnifying optical devices will be coupled to package 200. Maintaining a proper optical focal length is critical. Display cover 500 has registration features that account for this critical focal length. As seen in FIG. 13, a variety of registration features 530 are provided on the outer surface of display cover 500.

FIG. 15 is an isometric view of the back side of display cover 500. Shown are registers 540. Registers 540 contact cover glass 102 of LCOS device 210 to provide a registration that accounts for the critical optical focal length.

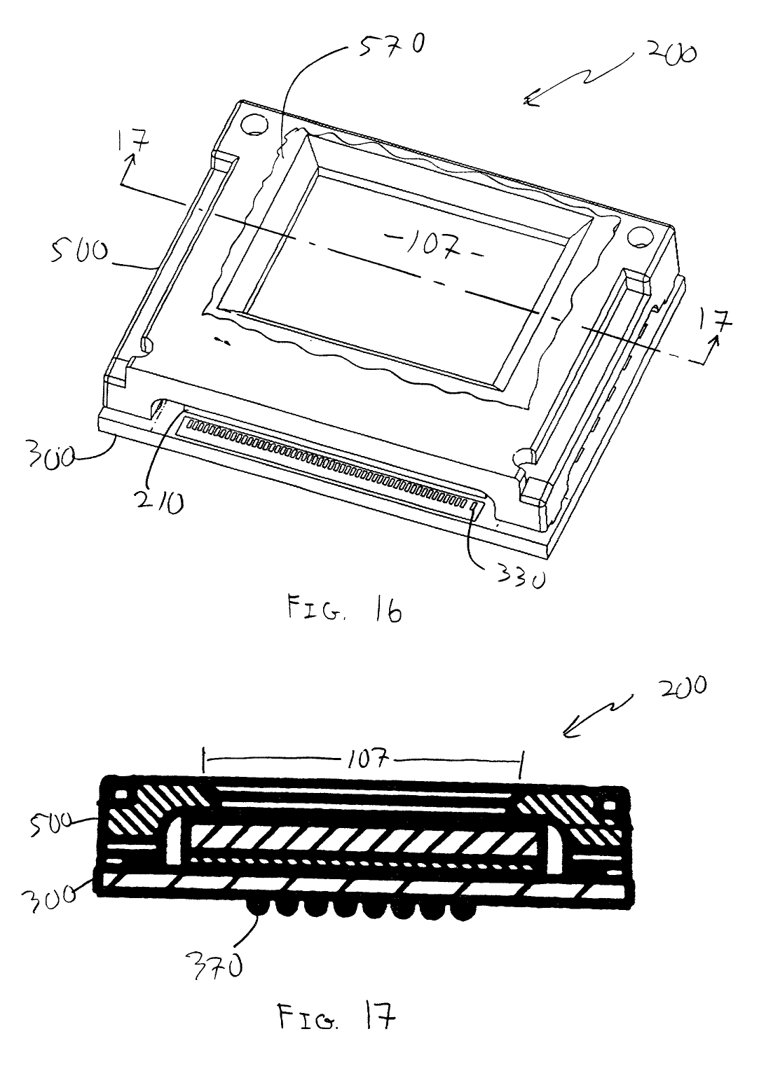

FIG. 16 is an isometric view of display assembly 200 in its ready to ship configuration. Prior to shipping, display cover 500 is covered by protective film material 570. Protective film 570 serves as a safe surface for picking and placing display assembly package 200. Protective film 570 may be, for example, a blue protective film manufactured by Semiconductor Equipment Corporation as part number 118733-11.0. FIG. 17 is section view of display assembly 200 of FIG. 16 taken off of line 17-17.

Several benefits are derived from the invention. For example, since the contacts of the LCD panel are brought from the viewing side of the LCD panel to the bottom of the packaging, the footprint of the package may be maintained within the BGA substrate 300. The exemplary embodiments described herein are provided merely to illustrate the principles of the invention and should not be construed as limiting the scope of the terms of the invention. Rather, the principles of the invention may be applied toward a wide range of systems to achieve the advantages described herein and to achieve other advantages or to satisfy other objectives, as well.

What is claimed is:

1. A display assembly, comprising:
a liquid crystal on silicon display device disposed on a first substrate and having first electrical contact pads; and
a second substrate having second electrical contact pads coupled to the first electrical contact pads and having an array of ball contact elements.

2. The display assembly of claim 1 wherein the array of ball contact elements are disposed on a first side of the second substrate and the second contact pads are disposed on a second side of the second substrate where the first side is opposite the second side.

3. A display assembly comprising:
a display device disposed on a first substrate and having first electrical contact pads; and
a second substrate having second electrical contact pads coupled to said first electrical contact pads and having an array of ball contact elements,
wherein the display device forms an image near a surface of the first substrate.

4. In a micro liquid crystal display assembly package having a micro liquid crystal display, a ball grid array substrate, comprising:
a carrier board having circuitry; and
a plurality of capacitors coupled to the carrier board.

5. The ball grid array substrate of claim 4 further comprising a power signal, wherein the plurality of capacitors restrict power signal variations to less than one percent variation.

6. The ball grid array substrate of claim 5 wherein each capacitor resides within a 18.0 mm by 18 mm perimeter wherein the micro liquid crystal display is disposed within this perimeter.

7. The ball grid array substrate of claim 6 wherein each capacitor resides within a 9.0 mm by 18 mm perimeter wherein the micro liquid crystal display is disposed within this perimeter.

8. The ball grid array substrate of claim 5 further comprising a first and second set of balls populating the carrier board wherein the second set of balls comprise a thermal area that works to conduct heat away from the carrier board.

9. The ball grid array substrate of claim 5 further comprising at least three height beads disposed on the carrier board wherein each bead extending a uniform distance from the carrier board.
